(19) United States
(12) Patent Application Publication
(10) Pub. No.: US 2022/0083848 A1
(43) Pub. Date: Mar. 17, 2022

(54) ARITHMETIC DEVICE, COMPUTER SYSTEM, AND ARITHMETIC METHOD

(71) Applicant: Kioxia Corporation, Tokyo (JP)

(72) Inventors: Daisuke MIYASHITA, Kawasaki (JP); Radu BERDAN, Shinagawa (JP); Yasuto HOSHI, Yokohama (JP); Jun DEGUCHI, Kawasaki (JP)

(73) Assignee: Kioxia Corporation, Tokyo (JP)

(21) Appl. No.: 17/195,775

(22) Filed: Mar. 9, 2021

(30) Foreign Application Priority Data
Sep. 16, 2020 (JP) 2020-155200

(51) Int. Cl. G06N 3/063; G06K 9/62; G06F 17/16; G06F 7/544

(52) U.S. Cl. CPC G06N 3/0635; G06K 9/6215; G06F 7/5443; G06F 17/16; G06K 9/6228

(57) ABSTRACT

According to an embodiment, an arithmetic device configured to execute an operation related to a neural network approximately calculates similarities between a first vector and a plurality of second vectors. Further, the arithmetic device selects, among the plurality of second vectors, a plurality of third vectors whose similarities are equal to or greater than a threshold. Furthermore, the arithmetic device also calculates similarities between the first vector and the selected plurality of third vectors.

### CROSS-REFERENCE TO RELATED APPLICATIONS

This application is based upon and claims the benefit of priority from Japanese Patent Application No. 2020-155200, filed on Sep. 16, 2020; the entire contents of which are incorporated herein by reference.

### FIELD

Embodiments described herein relate generally to an arithmetic device, a computer system, and an arithmetic method.

### BACKGROUND

Conventionally, neural networks including Attention, which is a process of calculating a weighted sum of another matrix by using a result of a vector matrix product as a weight, have been widely used for operations in natural language processing (NLP). The NLP includes multiple processes for processing human language (natural language) by machine. The neural networks including Attention are also being considered for employment in the field of image processing.

### BRIEF DESCRIPTION OF THE DRAWINGS

FIG. 1 is a block diagram illustrating an example of a configuration of a computer system including an arithmetic device of an embodiment;

FIG. 2 is a schematic diagram for explaining a configuration example of a neural network executed by the computer system of the embodiment;

FIG. 3 is a functional block diagram illustrating a functional configuration of an arithmetic device of the embodiment;

FIG. 4 is a flowchart illustrating a flow of various processes (data processing method) by the arithmetic device of the embodiment;

FIG. 5 is a diagram illustrating an example of approximate calculation of a vector matrix product of the embodiment;

FIG. 6 is a modification example of a functional block diagram illustrating a functional configuration of the arithmetic device of the embodiment;

FIG. 7 is a diagram illustrating an example of processing in a neural network of a comparative example; and

FIG. 8 is a diagram illustrating an example of an analog product-sum arithmetic unit according to the embodiment.

### DETAILED DESCRIPTION

According to an embodiment, an arithmetic device configured to execute an operation related to a neural network approximately calculates similarities between a first vector and a plurality of second vectors. Further, the arithmetic device selects, among the plurality of second vectors, a plurality of third vectors whose similarities are equal to or greater than a threshold based on a result of the calculation of the similarity. Furthermore, the arithmetic device calculates similarities between the first vector and the selected plurality of third vectors.

The arithmetic device, a computer system, and an arithmetic method according to the embodiment will be described in detail below with reference to the accompanying drawings. Note that the present invention is not limited to the present embodiment.

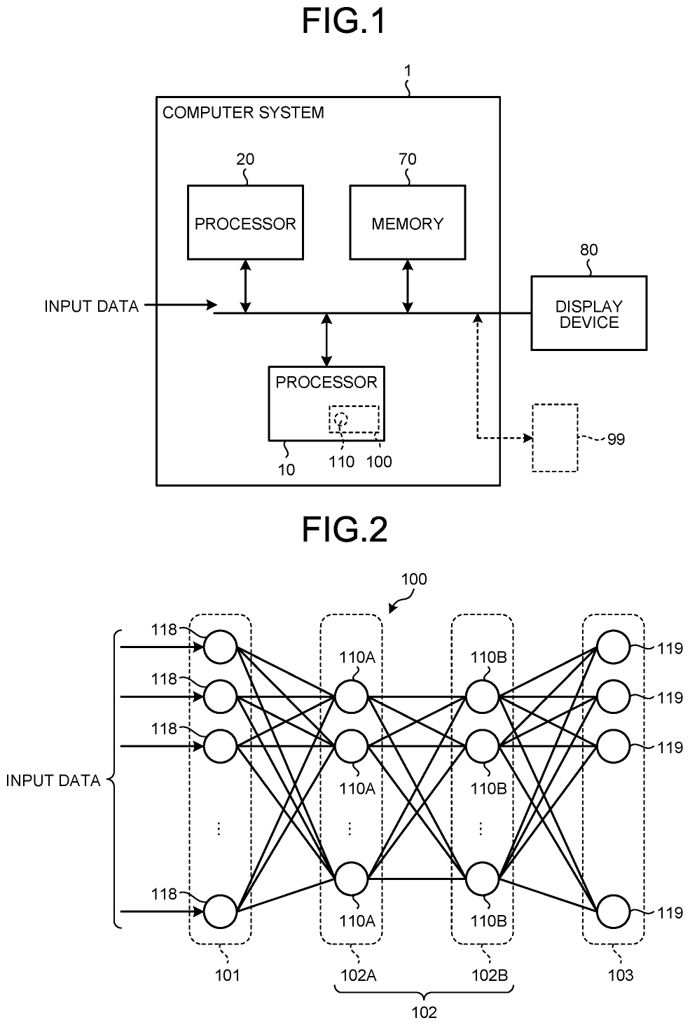

FIG. 1 is a block diagram illustrating an example of a configuration of a computer system 1 including an arithmetic device of an embodiment. As illustrated in FIG. 1, the computer system 1 receives input data. The input data may be, for example, voice data, text data generated from voice data, or image data. The computer system 1 executes various processes on the input data. For example, when the input data is voice data, the computer system 1 executes natural language processing.

The computer system 1 can output a signal corresponding to a processing result for the input data, and display the processing result on the display device 80. The display device 80 is a liquid crystal display, an organic EL display, or the like. The display device 80 is electrically connected to the computer system 1 via a cable or wireless communication.

The computer system 1 includes at least a graphic processing unit (GPU) 10, a central processing unit (CPU) 20, and a memory 70. The GPU 10, the CPU 20, and the memory 70 are communicably connected by an internal bus.

In the present embodiment, the GPU 10 executes an operation related to inference processing using a neural network 100, which will be described later, that is a machine learning device. The GPU 10 is a processor that approximately performs a similarity calculation described later. The GPU 10 executes processing on the input data while using the memory 70 as a work area. The GPU 10 has the neural network 100, which will be described later, that is a machine learning device.

The CPU 20 is a processor that controls an overall operation of the computer system 1. The CPU 20 executes various processes for controlling the GPU 10 and the memory 70. The CPU 20 uses the memory 70 as a work area to control operations related to the neural network 100, which will be described later, executed by the GPU 10.

The memory 70 functions as a memory device. The memory 70 stores input data input from the outside, data generated by the GPU 10, data generated by the CPU 20, and parameters of the neural network. Note that the data generated by the GPU 10 and by the CPU 20 may include intermediate results and final results of various calculations. For example, the memory 70 includes at least one or more selected from a DRAM, an SRAM, an MRAM, a NAND flash memory, a resistive random access memory (for example, ReRAM, Phase Change Memory (PCM)), or the like. A dedicated memory (not illustrated) for GPU 10 may be directly connected to the GPU 10.

The input data may be provided from a storage medium 99. The storage medium 99 is electrically connected to the computer system 1 by cable or wireless communication. The storage medium 99 functions as a memory device, and may be any of a memory card, a USB memory, an SSD, an HDD, and an optical storage medium, and the like.

FIG. 2 is a schematic diagram for explaining a configuration example of the neural network 100 executed by the computer system 1 of the embodiment.

In the computer system 1, the neural network 100 of FIG. 2 is used as a machine learning device. For example, the neural network 100 includes a multilayer perceptron (MLP), a convolutional neural network (CNN), or a neural network including an attention mechanism (for example, the Transformer). Here, machine learning is a technology in which a computer learns a large amount of data and automatically constructs an algorithm or a model for performing tasks such as classification and prediction.

Note that the neural network 100 may be any machine learning model that makes any inference. For example, the neural network 100 may be a machine learning model that inputs voice data and outputs the classification of the voice data, or may be a machine learning model that achieves noise removal and voice recognition of voice data.

The neural network 100 has an input layer 101, a hidden layer (also called an intermediate layer) 102, and an output layer (also called a fully connected layer) 103.

The input layer 101 receives input data (or a part thereof) received from the outside of the computer system 1. The input layer 101 has a plurality of arithmetic devices (also called neurons or neuron circuits) 118. Note that the arithmetic device 118 may be a dedicated device, or processing thereof may be implemented by executing a program by a general-purpose processor. From this point onward, the notation of arithmetic device will be used in similar meaning. In the input layer 101, each arithmetic device 118 performs arbitrary processing (for example, linear conversion, addition of auxiliary data, or the like) on the input data to convert the input data, and transmits the converted data to the hidden layer 102.

The hidden layer 102 (102A and 102B) executes various calculation processes on the data from the input layer 101.

The hidden layer 102 has a plurality of arithmetic devices 110 (110A and 110B). In the hidden layer 102, each arithmetic device 110 executes a product-sum operation process using a particular parameter (for example, a weighting coefficient) for supplied data (hereinafter, also referred to as device input data for distinction). For example, each arithmetic device 110 executes a product-sum operation process on the supplied data using parameters different from each other.

The hidden layer 102 may be layered. In this case, the hidden layer 102 includes at least two layers (a first hidden layer 102A and a second hidden layer 102B).

Each arithmetic device 110A of the first hidden layer 102A executes a particular calculation process on device input data that is a processing result of the input layer 101. Each arithmetic device 110A transmits a calculation result to each arithmetic device 110B of the second hidden layer 102B. Each arithmetic device 110B of the second hidden layer 102B executes a particular calculation process on device input data that is a calculation result of each arithmetic device 110A. Each arithmetic device 110B transmits a calculation result to the output layer 103.

Thus, when the hidden layer 102 has a hierarchical structure, an ability of inference, learning (or training), and classification by the neural network 100 can be improved. Note that the number of hidden layers 102 may be three or more, or one. One hidden layer may be configured to include any combination of processes such as product-sum operation process, pooling process, normalization process, and activation process.

The output layer 103 receives results of various calculation processes executed by each arithmetic device 110 of the hidden layer 102, and executes various processes.

The output layer 103 has a plurality of arithmetic devices 119. Each arithmetic device 119 executes a particular process on device input data that is a calculation result from the plurality of arithmetic devices 110B. Thus, the neural network 100 can execute inference and classification regarding data supplied to the neural network 100 based on a calculation result by the hidden layer 102. Each arithmetic device 119 can store and output an obtained processing result (or classification result). The output layer 103 also functions as a buffer and an interface for outputting calculation results of the hidden layer 102 to the outside of the neural network 100.

Note that the neural network 100 may be provided outside the GPU 10. That is, the neural network 100 may be implemented by using not only the GPU 10 but also the CPU 20, the memory 70, the storage medium 99, and the like in the computer system 1.

In the computer system 1 of the present embodiment, various calculation processes for natural language processing/estimation and various calculation processes for machine learning (for example, deep learning) of natural language processing/estimation are executed by, for example, the neural network 100.

For example, in the computer system 1, based on various calculation processes on voice data by the neural network 100, it is possible to infer (recognize) and classify what the voice data is by the computer system 1, or to perform learning so that the voice data is recognized or classified with high precision by the computer system 1.

In the present embodiment, as described below, the arithmetic device 110 (110A and 110B) in the neural network 100 includes one or more processing circuits.

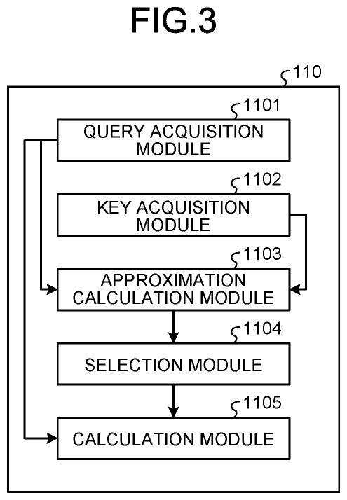

FIG. 3 is a functional block diagram illustrating a functional configuration of the arithmetic device 110 of the embodiment. As illustrated in FIG. 3, the arithmetic device 110 includes a query acquisition module 1101, a key acquisition module 1102, an approximation calculation module 1103, a selection module 1104, and a calculation module 1105.

The query acquisition module 1101 acquires a vector as a query related to supplied device input data. The key acquisition module 1102 acquires a matrix as an array of n keys related to the supplied device input data.

The approximation calculation module 1103 functions as a first calculator, and approximately calculate similarities between a d-dimensional vector (first vector) as a query and n d-dimensional vectors (matrix as an array of n keys) that are a plurality of second vectors.

The selection module 1104 selects, among the plurality of second vectors, a plurality of keys that are vectors (third vectors) whose similarities are equal to or greater than a threshold based on a result of the calculation of the similarity in the approximation calculation module 1103.

The calculation module 1105 functions as a second calculator, and calculates similarities between the query and the k keys selected by the selection module 1104.

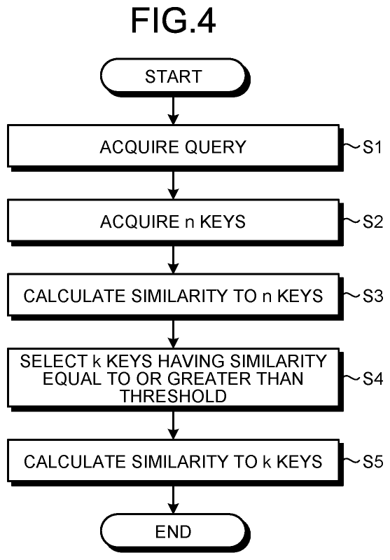

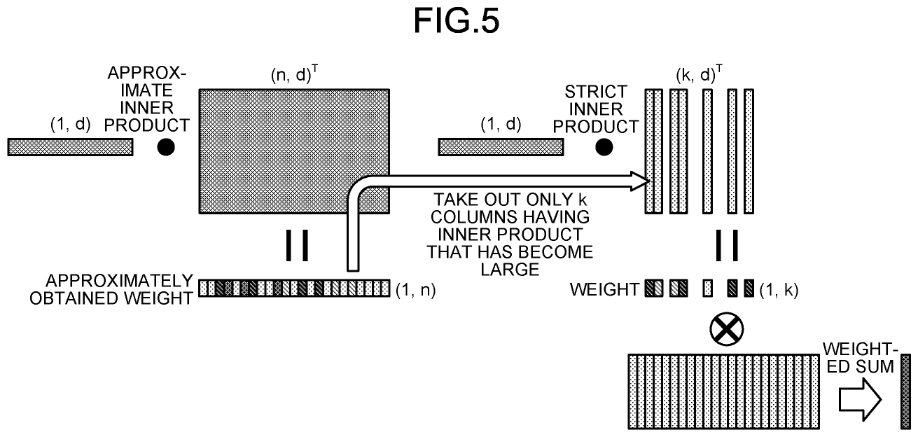

Here, FIG. 4 is a flowchart illustrating a flow of various processes (data processing method) by the arithmetic device 110 of the embodiment, and FIG. 5 is a diagram illustrating an example of approximate calculation of a vector matrix product of the embodiment. The vector matrix product can be regarded as a process of searching for a key corresponding to a query by using a vector as a query and a matrix as an array of keys. Note that the array of key here has n d-dimensional vectors (keys).

As illustrated in FIG. 4, the query acquisition module 1101 acquires a vector as a query related to supplied device input data (S1).

Further, the key acquisition module 1102 acquires a matrix as an array of n keys related to the supplied device input data (S2).

Next, the approximation calculation module 1103 approximately calculates similarities between the vector as a query and the matrix as an array of keys (S3). That is, the approximation calculation module 1103 ranks the keys by the similarities to the query. In other words, the approximation calculation module 1103, in the calculation of the similarity, reduces precision of one or both of the d-dimensional vector (first vector) as a query and the n d-dimensional vectors (plurality of second vectors), and approximately calculates the similarity by executing an inner product calculation using the vector or vectors with the reduced precision.

As illustrated in FIG. 5, first, the approximation calculation module 1103 obtains the vector matrix product that is the similarity from the approximate inner product between a d-dimensional vector (1, d) as a query and each of a matrix (n, d)^{T} as an array of n d-dimensional vectors (keys). At this time, the approximation calculation module 1103 approximates the query and the key by quantizing them into low bits. The quantizing into low bits means, for example, converting a query or key that was originally expressed in a single-precision floating-point type into a type that can be processed at high speed with low bits, such as an eight-bit integer or a four-bit integer. In order to perform such an approximation, the vector matrix product obtained here is an approximately obtained weight (1, n).

Next, as illustrated in FIG. 4, the selection module 1104 selects k keys whose similarities are equal to or greater than the threshold (S4). That is, as illustrated in FIG. 5, the selection module 1104 selects a small number of columns (here, k) in which a value of the inner product has become equal to or greater than the threshold in the approximately obtained weight (1, n) to have (k, d)^{T}.

Note that this threshold may be a predetermined value set in advance, or may be determined according to the value of the inner product so that the number of selected columns becomes the number k set in advance.

Then, as illustrated in FIG. 4, the calculation module 1105 calculates similarities for k keys (S5). As illustrated in FIG. 5, the calculation module 1105 strictly calculates the vector matrix product with a d-dimensional vector (1, d) as a query for a small matrix (k, d)^{T} obtained by extracting a column selected from the original matrix (n, d)^{T}. The vector matrix product obtained here is a weight (1, k).

The result of the vector matrix product calculated in this manner is used as a weight for taking a weighted sum.

As described above, one of features of the arithmetic device 110 of the present embodiment is that the selected d-dimensional vector (key) changes according to the d-dimensional vector (1, d) as a query.

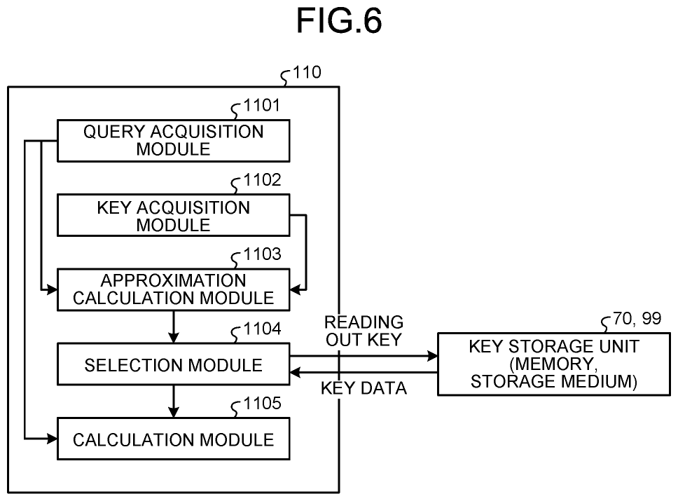

Note that the k keys selected by the selection module 1104 and used by the calculation module 1105 are not limited to those in which a part of n pieces of key data itself existing in the approximation calculation module 1103 is passed. FIG. 6 is a modification example of a functional block diagram illustrating a functional configuration of the arithmetic device 110 of the embodiment. As illustrated in FIG. 6, key data corresponding to n keys is stored in the memory 70 or the storage medium 99 that functions as a key storage unit (storage unit). At this time, the key data is stored with indices by which n keys can be identified. The embodiment may be such that in the selection module 1104, k indices indicating columns whose similarities are equal to or greater than the threshold are selected, and in the calculation module 1105, key data corresponding to the selected k indices are read out from the memory 70 or the storage medium 99 that function as the key storage unit and used.

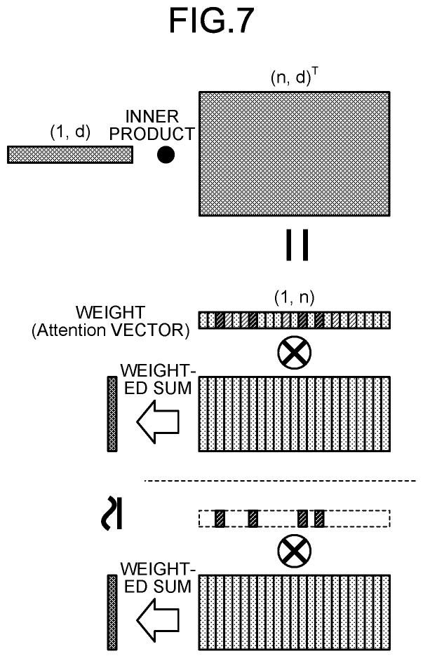

FIG. 7 is a diagram illustrating an example of processing in a neural network of a comparative example. As illustrated in FIG. 7, the neural network of the comparative example includes a process (attention mechanism, Attention) of calculating the weighted sum of another matrix by using a result of the vector matrix product as a weight. As illustrated in FIG. 7, in the neural network of the comparative example, there is a problem that the calculation amount of the vector matrix product: d×(d, n) becomes very large particularly when n is large.

However, in the neural network of the comparative example, the distribution of results of the vector matrix product used as a weight for taking the weighted sum is often biased, and many of them can consequently be ignored (the weight becomes almost zero).

Therefore, in the present embodiment, in the neural network including a process that can be regarded as a key search corresponding to a vector as a query, first, a key search calculation is approximately performed to narrow down candidates, and thereafter the key search calculation is performed again for a small number of narrowed down keys as a target. Thus, in the present embodiment, by performing the calculation approximately, the speed can be increased, so that cost such as processing time can be reduced.

Note that in the present embodiment, the ranking of the related keys by the similarities to the query is obtained by the approximate inner product, but the present embodiment is not limited to this, and a calculation method other than the inner product may be used. Further, in the present embodiment, for example, the ranking of related keys by the similarities to the query may be calculated using cosine similarity, Hamming distance, or the like.

Further, although the GPU 10 is used as a dedicated processor for approximately performing the similarity calculation in the present embodiment, the present invention is not limited to this, and the CPU 20 may perform the approximate similarity calculation. In this case, the CPU 20 implements the arithmetic device. Further, as the approximation method, the method of quantizing queries and keys to low bits has been illustrated, but other approximation methods may be used. For example, when the inner product calculation can be accelerated, an approximation method such as treating an internal value of each element of a vector of a query or a key smaller than a predetermined value as zero can be mentioned. As the approximation method, an analog product-sum arithmetic unit using a resistive random access memory or the like may be used to perform the approximate similarity calculation. In this case, an analog product-sum arithmetic unit using a resistive random access memory achieves the arithmetic device.

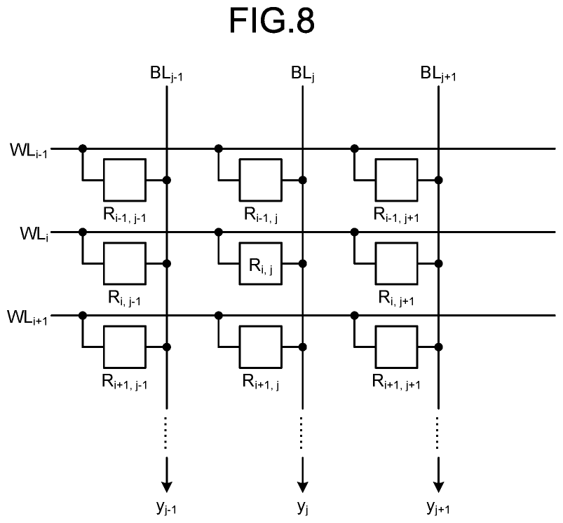

FIG. 8 illustrates an example of an analog product-sum arithmetic unit. The analog product-sum arithmetic unit is constituted of, for example, a plurality of wirings WL in a horizontal direction (row direction), a plurality of wirings BL in a vertical direction (column direction), and a resistance element whose terminals are connected to the WL and BL at their intersection. FIG. 8 illustrates three rows and three columns which are three rows from i−1 to i+1 and three columns from j−1 to j+1, which illustrate, for example, only a part of d rows and n columns. Here, each of d and n is an integer of two or more, i is an integer of one or more and d−2 or less, and j is an integer of one or more and n−2 or less. When an input voltage is applied to each WL, a current is generated according to the voltage value and the resistance value of the resistance element, and a current flows through each BL. The currents generated on the same BL are added to be an output y. Thus, when the voltage value applied to each row of d rows is a d-dimensional vector and the reciprocal of the resistance value (conductance) of the resistance element in the d rows and n columns is a matrix of (n, d)^{T}, a process corresponding to the vector matrix product is executed.

Note that the arithmetic device of the present embodiment, the computer system including the arithmetic device of the present embodiment, and the storage medium that stores the arithmetic method of the present embodiment can be applied to smartphones, mobile phones, personal computers, digital cameras, in-vehicle cameras, monitoring cameras, security systems, AI devices, system libraries (databases), and artificial satellites and the like.

In the above description, the example has been illustrated in which the arithmetic device, the computer system, and the arithmetic method of the present embodiment are applied to the neural network in the computer system 1 related to natural language processing that processes a human language (natural language) by machine. However, the arithmetic device and the arithmetic method of the present embodiment can be applied to various computer systems including a neural network and various data processing methods for executing a calculation process by neural network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arithmetic device configured to execute an operation related to a neural network, the arithmetic device being configured to:
approximately calculate similarities between a first vector and a plurality of second vectors;
select, among the plurality of second vectors, a plurality of third vectors whose similarities are equal to or greater than a threshold based on a result of the calculation of the similarity; and
calculate similarities between the first vector and the selected plurality of third vectors.

2. The arithmetic device according to claim 1, wherein
the arithmetic device is further configured to, in the calculation of the similarity, reduce precision of one or both of the first vector and the plurality of second vectors, and approximately calculate the similarities by executing an inner product calculation using the vector or the vectors with the reduced precision.

3. The arithmetic device according to claim 1, wherein
the arithmetic device is further configured to approximately calculate the similarities using an analog product-sum arithmetic unit configured to execute a product-sum operation by a method of applying a voltage to resistance elements to generate currents according to a resistance value and a voltage value and add the generated currents.

4. The arithmetic device according to claim 1, wherein the arithmetic device is further configured to:
store data of the plurality of second vectors;
select the plurality of third vectors whose similarities are equal to or greater than the threshold;
read out data of second vectors, among the plurality of second vectors, corresponding to the selected plurality of third vectors; and
calculate the similarities with the first vector using the read data.

5. A computer system comprising:
an arithmetic device configured to execute an operation related to a neural network; and
a memory device configured to store data operated by the arithmetic device, wherein
the arithmetic device is configured to:
approximately calculate similarities between a first vector and a plurality of second vectors;
select, among the plurality of second vectors, a plurality of third vectors whose similarities are equal to or greater than a threshold based on a result of the calculation of the similarity; and
calculate similarities between the first vector and the selected plurality of third vectors.

6. The computer system according to claim 5, wherein the arithmetic device is further configured to, in the calculation of the similarity, reduce precision of one or both of the first vector and the plurality of second vectors, and approximately calculate the similarities by executing an inner product calculation using the vector or the vectors with the reduced precision.

7. The computer system according to claim 5, wherein
the arithmetic device is further configured to approximately calculate the similarities using an analog product-sum arithmetic unit configured to execute a product-sum operation by a method of applying a voltage to resistance elements to generate currents according to a resistance value and a voltage value and add the generated currents.

8. The computer system according to claim 5, wherein
the arithmetic device is further configured to:
store data of the plurality of second vectors in the memory device;
select the plurality of third vectors whose similarities are equal to or greater than the threshold;
read out data of second vectors, among the plurality of second vectors, corresponding to the selected plurality of third vectors from the memory device; and
calculate the similarities with the first vector using the read data.

9. An arithmetic method in an arithmetic device configured to execute an operation related to a neural network, the method comprising:
approximately calculating similarities between a first vector and a plurality of second vectors;
selecting, among the plurality of second vectors, a plurality of third vectors whose similarities are equal to or greater than a threshold based on a result of the calculation of the similarity; and
calculating similarities between the first vector and the selected plurality of third vectors.

10. The arithmetic method according to claim 9, further comprising,
in the calculation of the similarity, reducing precision of one or both of the first vector and the plurality of second vectors, and approximately calculating the similarities by executing an inner product calculation using the vector or the vectors with the reduced precision.

11. The arithmetic method according to claim 9, further comprising
approximately calculating the similarities using an analog product-sum arithmetic unit configured to execute a product-sum operation by a method of applying a voltage to resistance elements to generate currents according to a resistance value and a voltage value and add the generated currents.

12. The arithmetic method according to claim 9, further comprising:
storing data of the plurality of second vectors;
selecting the plurality of third vectors whose similarities are equal to or greater than the threshold;
reading out data of second vectors, among the plurality of second vectors, corresponding to the selected plurality of third vectors; and
calculating the similarities with the first vector using the read data.
